(19) United States
(12) Patent Application Publication
(10) Pub. No.: US 2019/0057367 A1
(43) Pub. Date: Feb. 21, 2019

(54) METHOD AND APPARATUS FOR HANDLING MIS-RINGING OF PRODUCTS

(71) Applicant: Walmart Apollo, LLC, Bentonville, AR (US)

(72) Inventors: Greg A. Bryan, Centerton, AR (US); Cristy C. Brooks, Cassville, MO (US); David Blair Brightwell, Bella Vista, AR (US); Benjamin D. Enssle, Bella Vista, AR (US); Jesse L. Eaton, Springdale, AR (US)

(21) Appl. No.: 16/102,057

(22) Filed: Aug. 13, 2018

Related U.S. Application Data
(60) Provisional application No. 62/546,788, filed on Aug. 17, 2017.

(51) Int. Cl. G06Q 20/20; G06K 9/00; G06Q 10/08

(52) U.S. Cl. CPC G06Q 20/203; G06Q 10/087; G06K 9/00671; G06Q 20/208

(57) ABSTRACT

Images or other sensed data involving a sales transaction are received from a network. The sales information from the transaction is also received from the network. A reconciliation is performed between the images and the sales information. When the reconciliation identifies a discrepancy between the sales information and the images or other sensed data, one or more perpetual inventory (PI) values of one or more products are adjusted to a value so as to correct for the discrepancy.

### CROSS-REFERENCE TO RELATED APPLICATION

This application claims the benefit of the following U.S. Provisional Application No. 62/546,788 filed Aug. 17, 2017, which is incorporated herein by reference in its entirety.

### TECHNICAL FIELD

These teachings relate generally to the purchasing of consumer products at a point-of-sales location and, more specifically, the verification of the accuracy of the purchases made at the point-of-sales location.

### BACKGROUND

Customers purchase products at retail stores and other establishments. To purchase an item, a customer typically takes the item to a point-of-purchase location (e.g., a cash register staffed with a human attendant) and the purchase is completed. The attendant may complete the transaction by scanning or otherwise entering the price of the item, and then accepting payment from the customer. In other examples, the customer may themselves scan the item using the point-of-sales device and then provide payment.

Sometimes the sales attendant enters and/or records the wrong product during the sales transaction. In aspects, the sales attendant may misread or be confused about a product and entered the wrong product identification information (e.g., product number). To take one specific example, soup cans of a particular brand may have the same general appearance. In this case, a can of chicken noodle soup may be incorrectly entered as a can of chicken and rice soup.

The mis-entry (mis-ringing) of products causes various problems for retailers. For example, perpetual inventory (PI) values may indicate the amount of a product at a store. In aspects, product re-ordering and/or restocking is triggered by the PI values. If the PI value is incorrect, then the optimal amount of a given product may not be present in the store.

Products may also be intentionally mis-entered. For example, a more expensive product may be intentionally rung up as a less expensive product. In this way, unscrupulous individuals can obtain expensive products at a discounted price.

### BRIEF DESCRIPTION OF THE DRAWINGS

The above needs are at least partially met through provision of approaches that reconcile purchases at a point-of-sales device particularly when studied in conjunction with the drawings, wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram of a system as configured in accordance with various embodiments of these teachings.

### DETAILED DESCRIPTION

Generally speaking, many of these embodiments reconcile images of a sales transaction that occurred at a point-of-sales device with sales data from that tarnsaction. When there is a discrepancy between the images and the sales data, various actions can be taken to resolve or deal with the discrepancy.

In some of these embodiments, a system that is configured to identify mis-ringing of products in a retail store includes a network, a point-of-sales apparatus, a sensor, and a control circuit. The point-of-sale apparatus is configured to collect sales information for a product that is purchased by a customer during a sales transaction. The point-of-sales apparatus transmits the sales information over the network.

The sensor is disposed in proximate relation to the point-of-sales apparatus. The sensor is configured to obtain images or other sensed data of the product as the product is being purchased during the sales transaction, and transmit the images or other sensed data over the network.

The control circuit is coupled to the network. The control circuit is configured to receive the images or other sensed data from the network, receive the sales information from the network, and perform a reconciliation between the images or other sensed data, and the sales information. When the reconciliation identifies a discrepancy between the sales information and the images or other sensed data, the control circuit is configured to adjust one or more perpetual inventory (PI) values of one or more products so as to correct for the discrepancy.

In aspects, the one or PI values comprise a first PI value of a first product and a second PI value of a second product. In examples, the sensor is a camera, a DNA sensor, and a laser. Other examples are possible.

In one example, the reconciliation determines that a physical characteristic associated with the product is a cause of the discrepancy. In aspects, the physical characteristic may be one or more of the label on the product, the size of the product, or the type of the product.

In other examples, the control circuit determines an error rate based upon results of the reconciliation. In yet other examples, training is offered to employees of the retail store when the error rate exceeds a predetermined value.

In still other examples, the reconciliation determines that product shrinkage has occurred. In other aspects, the reconciliation is performed when a trigger is received from the point-of-sales apparatus. In yet other aspects, the trigger is an indication of the entering of a quantity value by a cashier at the point-of-sales apparatus, or when the product has a likelihood for mis-rings that exceeds a predetermined threshold (e.g., based upon the number of previous mis-rings).

In others of these embodiments, sales information is collected at a point-of-sale apparatus for a product that is purchased by a customer during a sales transaction, and the sales information is transmitted over the network. Images or other sensed data of the product are obtained at a sensor as the product is being purchased during the sales transaction, and the images or other sensed data are transmitted over the network.

The images or other sensed data are received from the network. The sales information is also received from the network. A reconciliation is performed between the images or other sensed data, and the sales information. When the reconciliation identifies a discrepancy between the sales information and the images or other sensed data, one or more perpetual inventory (PI) values of one or more products are adjusted to a value so as to correct for the discrepancy.

In still others of these embodiments, a system is configured to identify mis-ringing of products in a retail store and includes an electronic communications network, an automated vehicle, a database, an electronic point-of-sales apparatus, a first sensor, a second sensor, and a control circuit.

The database stores one or more perpetual inventory (PI) values. The electronic point-of-sale apparatus collects sales information for a product that is purchased by a customer during a sales transaction. The point-of-sales apparatus transmits the sales information over the network.

The first sensor is disposed in proximate relation to the point-of-sales apparatus. The first sensor is configured to obtain images of the product as the product is being purchased during the sales transaction, and transmit the images over the network.

The second sensor is disposed in proximate relation to the point-of-sales apparatus. The second sensor is configured to obtain other sensed data of the product as the product is being purchased during the sales transaction, and transmit the other sensed data over the network.

The control circuit coupled to the network, the control circuit being configured to receive the images and other sensed data from the network, receive the sales information from the network, and perform a reconciliation between the images and other sensed data, and the sales information. When the reconciliation identifies a discrepancy between the sales information, and the images and the other sensed data, the control circuit is configured to adjust the one or more PI values of one or more products so as to correct for the discrepancy. When the reconciliation identifies a discrepancy between the sales information, and the images and other sensed data, the control circuit is configured to send instructions to the automated vehicle to perform an action. The action includes investigating product availability in the store, moving existing ones of the product within the store, or prioritizing movement of newly ordered ones of the product from a delivery vehicle into the store. Other examples of actions are possible.

In yet others of these embodiments, an automated vehicle is provided. One or more perpetual inventory (PI) values are stored in a database. Sales information is collected at an electronic point-of-sale apparatus for a product that is purchased by a customer during a sales transaction, and transmitted the sales information over an electronic network.

Images of the product are obtained at a first sensor as the product is being purchased during the sales transaction, and the images are transmitted over the network. Other sensed data of the product is obtained as the product is being purchased during the sales transaction at a second sensor that is disposed in proximate relation to the point-of-sales apparatus. The other sensed data is transmitted over the network.

The images or other sensed data from the network. The sales information is also received from the network.

A reconciliation is performed between the images and other sensed data, and the sales information. When the reconciliation identifies a discrepancy between the sales information and the images or other sensed data, the one or more perpetual inventory (PI) values of one or more products are adjusted to a value (or values)so as to correct for the discrepancy.

When the reconciliation identifies a discrepancy between the sales information, and the images and other sensed data, instructions are sent to the automated vehicle to perform an action. The action includes investigating product availability in the store, moving existing ones of the product within the store, or prioritizing movement of newly ordered ones of the product from a delivery vehicle into the store. Other examples of actions are possible.

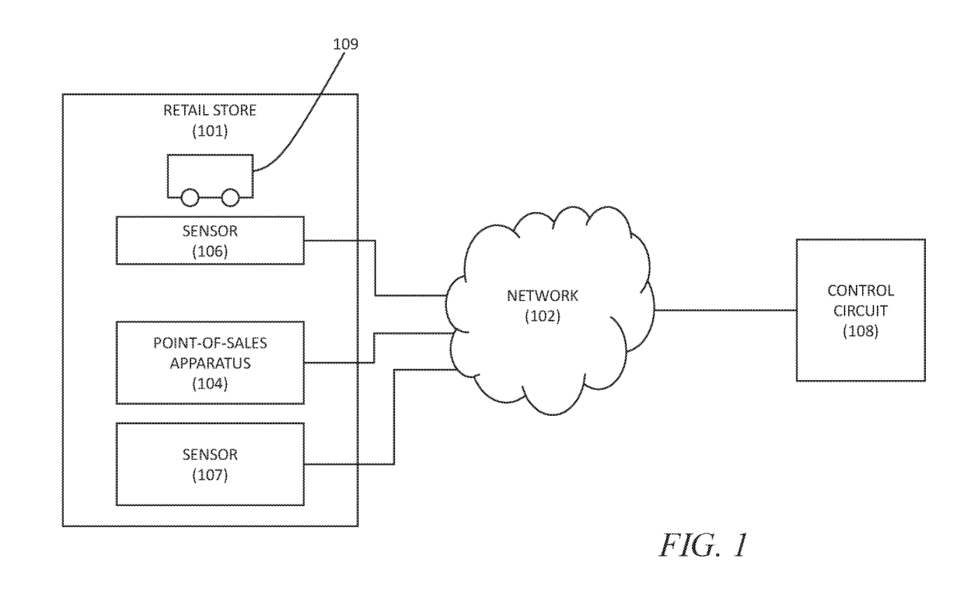

Referring now to FIG. 1, a system that is configured to identify mis-ringing of products in a retail store 101 includes a network 102, a point-of-sales apparatus 104, a first sensor 106, a second sensor 107, a control circuit 108, and an automated vehicle 109.

The retail store 101 may be any type of retail establishment where the public can directly purchase products. In other examples, the retail store 101 may be a warehouse or distribution center.

The point-of-sale apparatus 104 is configured to collect sales information for a product that is purchased by a customer during a sales transaction. The point-of-sales apparatus 104 transmits the sales information over the network 102. In examples, the point-of-sale apparatus 104 may be a cash register (or similar device) where a human cashier scans or otherwise enters sales data or a product that is being purchased. In other examples, the point-of-sale apparatus 104 may include a scanner that scans a bar code on the product.

The network 102 is any type of electronic communication network or combination of networks. In examples, the network 102 may include electronic components such as routers, gateways, or control circuits, to mention a few examples.

The first sensor 106 is disposed in proximate relation to the point-of-sales apparatus 104. For example, the first sensor 106 may be positioned to have a clear and unimpeded view of the sales transaction (when the first sensor is a camera), or so that the product can be easily positioned on the first sensor (when the sensor is a weight scale). The first sensor is configured to obtain images or other sensed data of the product as the product is being purchased during the sales transaction, and transmit the images or other sensed data over the network 102. In examples, the first sensor 106 is a camera, a weight scale, a DNA sensor, or a laser. Other examples of sensors are possible. In some aspects, the first sensor 106 is a camera and is configured to obtain images of the product as the product is being purchased during the sales transaction, and transmit the images over the network 102.

Multiple sensors may also be used. For instance, a second sensor 107 may also be disposed in proximate relation to the point-of sales apparatus 104. In examples, the second sensor 107 is a camera, a weight scale, a DNA sensor, or a laser. Other examples of second sensors are possible. In aspects, the second sensor 107 is configured to obtain other sensed data (besides image data) of the product as the product is being purchased during the sales transaction, and transmit the other sensed data over the network 102. In one exemplary example, the first sensor 106 obtains image data and the second sensor 107 obtains weight (or other non-image) data. In yet other examples, only a single sensor is used and this sensor obtains image (or any other type of) data.

The control circuit 108 is coupled to the network. The control circuit 108 may be disposed at a central processing location such as a central office that is associated with the retail store.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 108 may be configured (for example, by using corresponding programming stored in a memory as will be well understood by those skilled in the art) to carry out one or more of the steps, actions, and/or functions described herein.

The control circuit 108 is configured to receive the images or other sensed data from the network, receive the sales information from the network, and perform a reconciliation between the images or other sensed data, and the sales information. When the reconciliation identifies a discrepancy between the sales information and the images or other sensed data, the control circuit 108 is configured to adjust one or more perpetual inventory (PI) values of one or more products so as to correct for the discrepancy.

In other aspects, when the reconciliation identifies a discrepancy between the sales information, and the images and other sensed data, the control circuit is configured to send instructions to an automated vehicle 109 to perform an action. The action may include investigating product availability in the store 101, moving existing ones of the product within the store 101, or prioritizing movement of newly ordered ones of the product from a delivery vehicle into the store 101. Other examples of actions are possible.

In aspects, the one or PI values comprises a first PI value of a first product and a second PI value of a second product. In one example, the first PI value may need to be increased, while the second PI value may need to be decreased based upon the results of the reconciliation. Other examples of PI adjustments are possible.

In still other examples, the reconciliation performed by the control circuit 108 determines that a physical characteristic associated with the product is a cause of the discrepancy. This physical characteristic may include characteristics of the label on the product, the weight of the product, the size of the product, or the type of the product. Other examples of physical characteristics are possible.

The determination may be made, in one example, comparing past mis-rings to the current mis-ring. For example, when many mis-rings have occurred of products with similar labels, then the label may be identified as the reason for the current discrepancy.

In examples, the control circuit 108 determines an error rate based upon results of the reconciliation. In some other examples, training is offered to employees of the retail store 101 when the error rate associated with a particular product or product type exceeds a predetermined value.

A high error rate may indicate that certain types of products are difficult for store employees to correctly ring-up at the point-of-sales apparatus 104. For instance, soup cans having the same design and appearance except for the lettering (indicating different types of soups) may be problematic for entry by employees.

In other examples, the reconciliation determines that product shrinkage has occurred. By “shrinkage,” it is meant that an unauthorized (e.g., theft) of the product has occurred. For example, some unscrupulous individuals may attempt to pay for a less expensive product, while actually removing a more expensive product from the retail store 101.

In other examples, the reconciliation is performed when an electronic trigger is received from the point-of-sales apparatus 104. In aspects, the trigger is an indication of the entering of a quantity value by a cashier at the point-of-sales apparatus 104 (where the quantity value exceeds a predetermined threshold), or when the product has a likelihood for mis-rings that exceeds a predetermined threshold (e.g., based upon the number of previous mis-rings for the product).

As mentioned, the analysis by the control circuit 108 examines various parameters such as the color, size, shape, or weight of the product. A mapping may be made. For example, a product of a certain size, shape, and weight may be mapped to a certain product type. This type can be compared to the sales data to determine if any discrepancies exist. Consequently, these approaches increase the computational efficiency of the system since more accurate determinations are made.

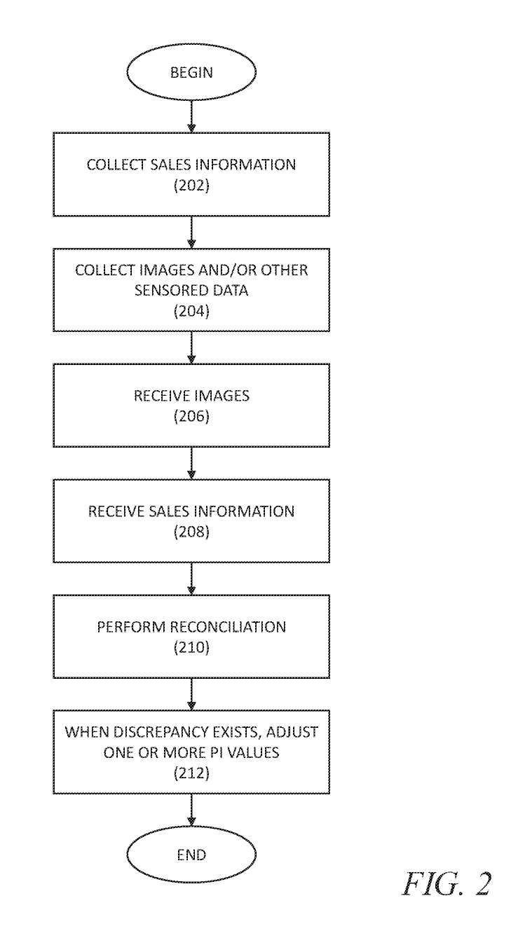

Referring now to FIG. 2, at step 202 sales information is collected at a point-of-sale apparatus for a product that is purchased by a customer during a sales transaction, and the sales information is transmitted over the network.

At step 204, images or other sensed data of the product are obtained at a sensor as the product is being purchased during the sales transaction, and the images or other sensed data are transmitted over the network. In this example, the images are obtained from a camera.

At step 206, the images or other sensed data are received from the network. The images may be received at a central processing center such as the home office of the retail store. The images may be in any type of format or arranged according to any type of image protocol.

At step 208, the sales information is received from the network. The sales information may include the type of product sold, the product number, and/or the number of products sold. Other examples of sales information are possible. The sales information may be transmitted electronically according to any type of electronic format or according to any type of protocol.

At step 210, a reconciliation is performed between the images (or other sensed data), and the sales information. The reconciliation may include an analysis that determines the type of product. In examples, the sensed information is mapped to a predetermined or preset type. For example, the size, weight, color, shape, or other characteristics are mapped to a product type. The determined product may be further associated with other information such as an item number for the product.

In one specific example, the images and other sensed data indicate the shape, color, and weight of a product. Different types of vegetable produce have characteristic sizes, weights, shapes, and colors. In this case, these characteristics may be mapped to specific types of produce. For instance, a certain weight, shape, and color of a product may indicate that the product is a carrot. Another type of weight, shape, and color may indicate that the product is a tomato. The determined product type (tomato) is further associated with a product number associated with tomatoes.

Once the product type is determined, the reconciliation compares the determined product type to the sales data. In this example and when it has been determined that the product is a tomato, the sales data is examined to determine if a tomato has been purchased. For instance, the sales data may be examined to see if the product number for a tomato is present.

In aspects, the date and time of the sales data and the sensed data are aligned with the date and time of the sensed data to ensure the proper sales transaction is being analyzed for a particular set of sensed data. In these regards, the sales data and sensed data may have time stamps, which are examined to ensure alignment in time.

At step 212 and when the reconciliation identifies a discrepancy between the sales information and the images or other sensed data, one or more perpetual inventory (PI) values of one or more products are adjusted to a value so as to correct for the discrepancy. In aspects, two PI values may be incorrect because a PI value that was adjusted, should not have been adjusted. Additionally, a PI value that should have been adjusted was not adjusted.

In the present example, a tomato was purchased, but incorrectly sold as a carrot. Thus, the PI value for carrots was incorrectly adjusted downward, and the PI value for tomatoes was incorrectly left unchanged. After the reconciliation is performed and in this case, the PI value for carrots is adjusted upward, and the PI value for tomatoes is decreased.

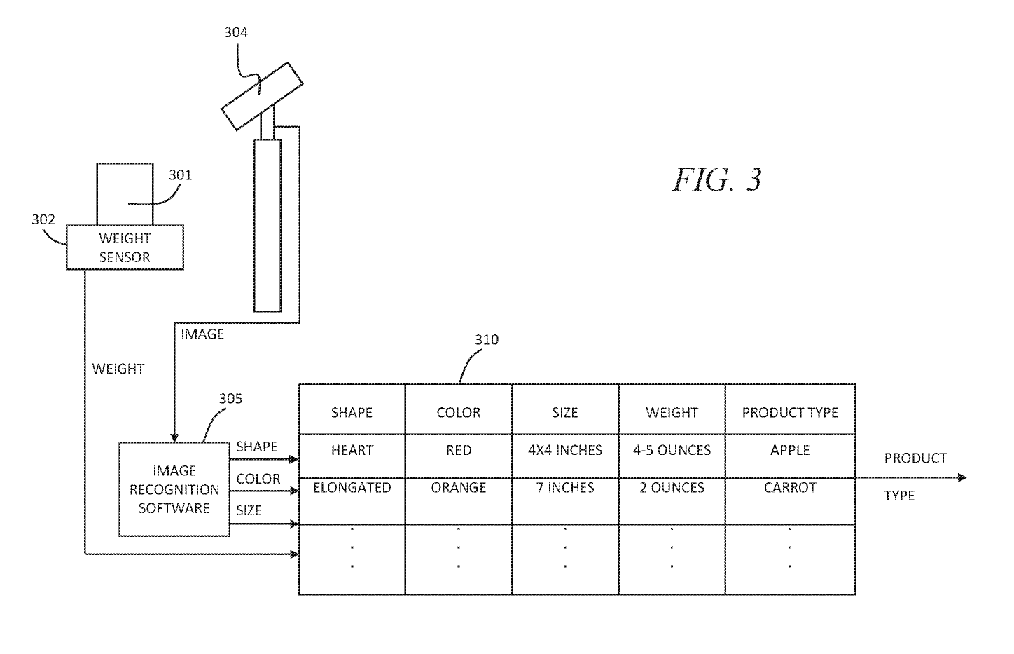

Referring now to FIG. 3, one example of the mapping (that determines a product type) is described. It will be appreciated that this is one example of a process that maps sensed data to a product type. Other types and examples of mapping processes are possible.

The product is placed on a weight sensor 302, which weighs the product 301. The weight sensor 302 may be any type of scale or similar device.

A camera 304 obtains an image of the product. In this case, the camera may sense visible images. However, other types of cameras (e.g., infrared) may obtain other types of images.

Image recognition software 305 (as is known to those skilled in the art) determines the shape of the product 301. In these regards, the image recognition software determines an overall outline of the image. The image recognition software 305 is also configured to determine the size (e.g., length, width, height, and/or thickness) of the product. In examples, the image recognition software 305 may examine pixels in the image for various properties (e.g., color or grayscale value) to determine the relevant outline and size information.

The outline of the product determined by the image recognition software 305 is of a particular shape. In examples, the outline may be compared to a group of predetermined shapes and the closest shape selected from the group of predetermined shapes. The group of predetermined shapes may be stored electronically in a database.

The image recognition software 305 also determines the color of the product 301. Colors may include basic colors (e.g., blue, green, yellow, and red), but may also include different shades of colors (e.g., light red, pink, rose, or barn red), or combinations of colors.

These characteristics (shape, size, color, and weight) serve as inputs to a table 310. The table 310 maps the inputs into a product type and the table 310 may be stored in a database.

In this example, a product is purchased in a grocery store. In this case, the product is a red apple, and the apple is placed on the weight sensor 302. The camera 304 obtains an image of the apple. Image processing software processes the image and obtains an outline of the apple. The outline is compared to other outlines stored in a library of images. One of the images stored in the library of images is of a heart-shaped object, and this image is determined to be the closet match.

The image recognition software 305 determines the color is red. The image recognition software also determines the dimensions of the apple (e.g., 4 by 4 inches).

The weight sensor measures the weight of the apple. In this case, the weight is 4 ounces.

The weight, shape, dimensions, and color information are applied as inputs to the table 305. The table 305 shows that a heart-shaped object, weighing approximately 4 ounces, 4 inches-by-four inches, and being of a red color is a red apple. Thus, the product type is identified as a red apple.

Once the product type is identified, then this information can be compared to sales data. For example, a product type of “red apple” may have a product number of “000011.” Sales data for the transaction may be examined to determine if “000011” is present.

It will be appreciated that these approaches may also determine the number of products sold and also reconcile this information with sales data. For example, it may be determined that three apples were sold and this number compared to sales information. If there was a match (e.g., the sales data also shows three apples as being sold), then there is no discrepancy. If there is not a match (e.g., the sales data shows only two apples as being sold), then there is a discrepancy and an appropriate action may be taken.

As mentioned, if the determined product type matches with the sales data, no further action need be taken. However, if the determined sales type does not match, then a discrepancy exists. The PI values of one or more products may be adjusted.

The types of mis-ringing errors may be analyzed to see if other corrective actions are needed. For example, if certain products are determined as being mis-rung by sales personnel, then training may be offered to the sales personnel to alleviate the problem.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system that is configured to identify mis-ringing of products in a retail store, the system comprising:
an electronic communications network;
an automated vehicle;
a database storing one or more perpetual inventory (PI) values;
an electronic point-of-sale apparatus that collects sales information for a product that is purchased by a customer during a sales transaction, the point-of-sales apparatus transmitting the sales information over the network;
a first sensor disposed in proximate relation to the point-of-sales apparatus, wherein the first sensor is configured to obtain images of the product as the product is being purchased during the sales transaction, and transmit the images over the network;
a second sensor disposed in proximate relation to the point-of-sales apparatus, wherein the second sensor is configured to obtain other sensed data of the product as the product is being purchased during the sales transaction, and transmit the other sensed data over the network;
a control circuit coupled to the network, the control circuit being configured to:
receive the images and other sensed data from the network;
receive the sales information from the network;
perform a reconciliation between the images and other sensed data, and the sales information;
when the reconciliation identifies a discrepancy between the sales information, and the images and the other sensed data adjust the one or more PI values of one or more products so as to correct for the discrepancy;
when the reconciliation identifies a discrepancy between the sales information, and the images and other sensed data, send instructions to the automated vehicle to perform an action, the action including investigating product availability in the store, moving existing ones of the product within the store, or prioritizing movement of newly ordered ones of the product from a delivery vehicle into the store.

2. The system of claim 1, wherein the one or PI values comprises a first PI value of a first product and a second PI value of a second product.

3. The system of claim 1, wherein the first sensor is a first camera and the second sensor is a device selected from the group consisting of a second camera, a DNA sensor, a scale, and a laser.

4. The system of claim 1, wherein the reconciliation determines that a physical characteristic associated with the product is a cause of the discrepancy, the physical characteristic being one or more of: a label on the product, a size of the product, or a type of the product.

5. The system of claim 1, wherein the control circuit determines an error rate based upon results of the reconciliation.

6. The system of claim 5, wherein training is offered to employees of the retail store when the error rate exceeds a predetermined value.

7. The system of claim 1, wherein the reconciliation determines that product shrinkage has occurred.

8. The system of claim 1, wherein the reconciliation is performed when a trigger is received from the point-of-sales apparatus.

9. The system of claim 8, wherein the trigger is an indication of the entering of a quantity value by a cashier at the point-of-sales apparatus, or when the product has a likelihood for mis-rings that exceeds a predetermined threshold.

10. A method to identify mis-ringing of products in a retail store, the method comprising:
providing an automated vehicle;
storing one or more perpetual inventory (PI) values in a database;
collecting sales information at an electronic point-of-sale apparatus for a product that is purchased by a customer during a sales transaction, and transmitting the sales information over an electronic network;
obtaining images of the product at a first sensor as the product is being purchased during the sales transaction, and transmitting the images over the network;
obtaining other sensed data of the product as the product is being purchased during the sales transaction at a second sensor that is disposed in proximate relation to the point-of-sales apparatus, and transmitting the other sensed data over the network;
receiving the images or other sensed data from the network;
receiving the sales information from the network;
performing a reconciliation between the images and other sensed data, and the sales information;
when the reconciliation identifies a discrepancy between the sales information and the images or other sensed data, adjusting the one or more perpetual inventory (PI) values of one or more products to a value so as to correct for the discrepancy;
when the reconciliation identifies a discrepancy between the sales information, and the images and other sensed data, sending instructions to the automated vehicle to perform an action, the action including investigating product availability in the store, moving existing ones of the product within the store, or prioritizing movement of newly ordered ones of the product from a delivery vehicle into the store.

11. The method of claim 10, wherein the one or PI values comprises a first PI value of a first product and a second PI value of a second product.

12. The method of claim 10, wherein the first sensor is a first camera and the second sensor is a device selected from the group consisting of a second camera, a DNA sensor, a scale, and a laser.

13. The method of claim 10, wherein the reconciliation determines that a physical characteristic associated with the product is a cause of the discrepancy, the physical characteristic being one or more of: a label on the product, a size of the product, or a type of the product.

14. The method of claim 10, further comprising determining an error rate based upon results of the reconciliation.

15. The method of claim 14, further comprising offering training to employees of the retail store when the error rate exceeds a predetermined value.

16. The method of claim 10, wherein the reconciliation determines that product shrinkage has occurred.

17. The method of claim 10, wherein the reconciliation is performed when a trigger is received from the point-of-sales apparatus.

18. The method of claim 17, wherein the trigger is an indication of the entering of a quantity value by a cashier at the point-of-sales apparatus, or when the product has a likelihood for mis-rings that exceeds a predetermined threshold.
